(19) United States
(12) Patent Application Publication
(10) Pub. No.: US 2011/0235118 A1
(43) Pub. Date: Sep. 29, 2011

(54) PRINTING METHOD USING A DUAL-ENGINE PRINTING SYSTEM

(76) Inventor: Gideon Amir, Nes-Zione (IL)

(21) Appl. No.: 13/132,852

(22) PCT Filed: Jan. 5, 2009
(86) PCT No.: PCT/US09/30155

§ 371 Date: Jun. 3, 2011

(51) Int. Cl. G06K 15/00

(52) U.S. Cl. 358/1.15

(57) ABSTRACT

Methods for printing using a dual-engine printing system are disclosed herein. An exemplary dual-engine printing system includes a first print engine, a second print engine, and a print media source including a continuous web or separate sheets of print media. Multiple first pairs of images each including a first image and a second image are printed on a first side of the print media by the first print engine, and multiple second pairs of images each including a first image and a second image are printed on a second side of the print media by the second print engine. The print media is then arranged, trimmed if necessary, and bound such the first image faces the second image for each of the first pairs of images as well as each of the second pairs of images. In another embodiment, each of the multiple pairs of images includes a first image printed on a first half of a sheet and a second image printed on the second half of the same sheet. The sheets are arranged and bound along a central axis such that each image from the first pairs of images faces another image from the first pairs of images, and each image from the second pairs of images faces another image from the second pairs of images.

### BACKGROUND

A dual-engine printing system typically has a single print media source connected to two print engines. With duplex printing, i.e., printing on both sides of the print media, higher productivity may be achieved by using a first engine of a dual-engine printing system to print the first (or “simplex”) side of the sheet of print media, and a second engine to print the second (or “duplex”) side of the sheet of print media. The printed sheets may then be stacked together and bound at the side or stitched and folded at the middle to create an album. When the album is opened, cross-pages (pages opposite to and facing one another) that were printed with different print engines tend to show different colors. Such a result may be particularly significant with photo albums, in particular where the images on cross-pages have the same or a similar background or foreground, have the same or a similar color scheme, are of the same subject in different poses, etc.

One solution may be to develop a very accurate color calibration system for both print engines. However, not only is this difficult to achieve, but a specific color calibration is also difficult to maintain over time.

### BRIEF DESCRIPTION OF THE DRAWINGS

FIG. 1 is a schematic illustration of an exemplary dual-engine printing system.

FIG. 2 is a schematic illustration of both sides of a continuous web of print media that have been printed in accordance with the method illustrated in FIG. 5.

FIG. 3 is a schematic illustration of the continuous web of print media of FIG. 2 that has been folded in accordance with the method illustrated in FIG. 5.

FIG. 4 is a schematic illustration showing an album being created using the method illustrated in FIG. 5.

FIG. 5 is a flow diagram illustrating a method of printing using a dual-engine printing system such as that shown in FIG. 1.

FIG. 6 is a schematic illustration of both sides of separate sheets of print media that have been printed in accordance with the method illustrated in FIG. 9.

FIG. 7 is a schematic illustration showing arrangement of the print media in accordance with the method illustrated in FIG. 9.

FIG. 8 is a schematic illustration showing an album being created in accordance with the method illustrated in FIG. 9.

FIG. 9 is a flow diagram illustrating another method of printing using a dual-engine printing system such as that shown in FIG. 1.

FIG. 10 is a schematic illustration of both sides of separate sheets of print media that have been printed in accordance with the method illustrated in FIG. 13.

FIG. 11 is a schematic illustration showing arrangement of the print media in accordance with the method illustrated in FIG. 13.

FIG. 12 is a schematic illustration showing an album being created in accordance with the method illustrated in FIG. 13.

FIG. 13 is a flow diagram illustrating another method of printing using a dual-engine printing system such as that shown in FIG. 1.

FIG. 14 is a schematic illustration showing multiple albums being created using any of the methods illustrated in FIG. 5, 9 or 13.

### DETAILED DESCRIPTION

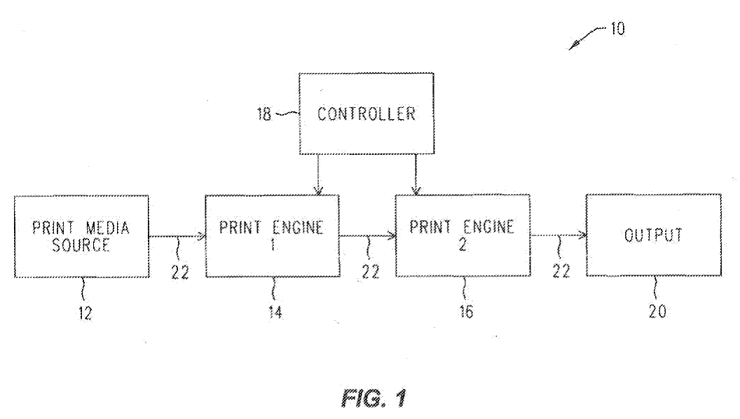

FIG. 1 schematically illustrates an exemplary dual-engine printing system 10. The system 10 may be, for example, an “Indigo” dual-engine printing press, Model w3250, manufactured by the Hewlett-Packard Company of Palo Alto, Calif., U.S.A. Such a system 10 may comprise a print media source 12 which may include a continuous web of print media and/or a supply of separate sheets of print media such as paper. The print media source 12 may also include a priming unit (not shown) or the like which may be a separate, inline unit that is adapted to prepare the print media for printing, as is known in the art. The system 10 may also comprise a first print engine 14 which is directly connected to the print media source 12 and is adapted to receive the print media therefrom. The system 10 may further comprise a second print engine 16 which is directly connected to the first print engine 14 and receives the print media therefrom after it exits the first print engine 14. Each of the print engines 14, 16 may include standard printing components such as, for example, an ink supply (preferably including several colored inks), one or more imaging cylinders, a writing head, and the like. A controller 18 connected to each of the print engines 14, 16 may be utilized to input images to be printed by each of the print engines 14, 16 and determine the order of images to be printed. Printing media exiting the second print engine 16 may be routed to an output unit or area 20, which may include a print media collator, trimmer, binder, and the like. The print media may be guided through the various components 12, 14, 16, 20 of the system 10 via a print media guide 22.

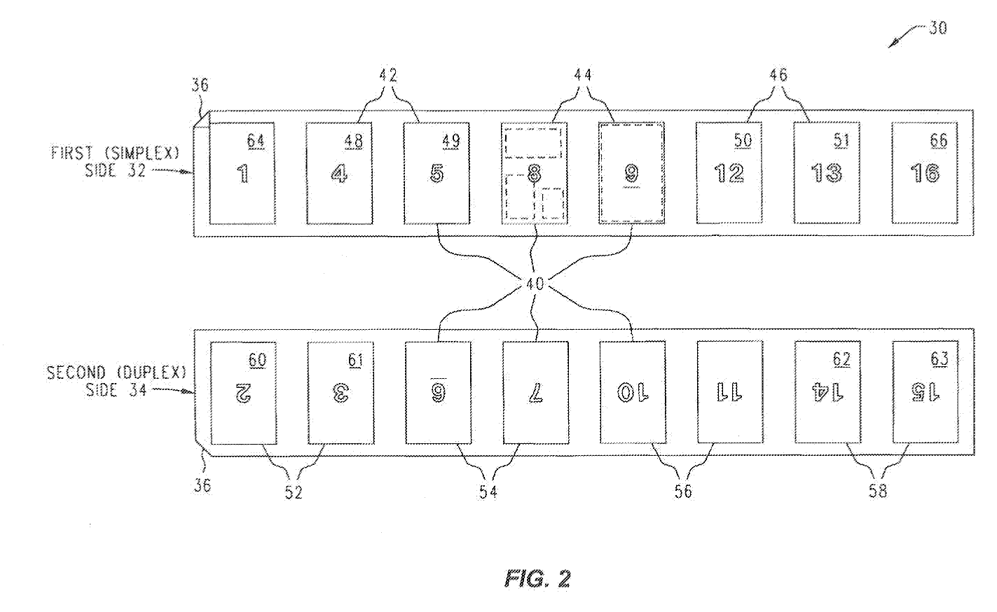

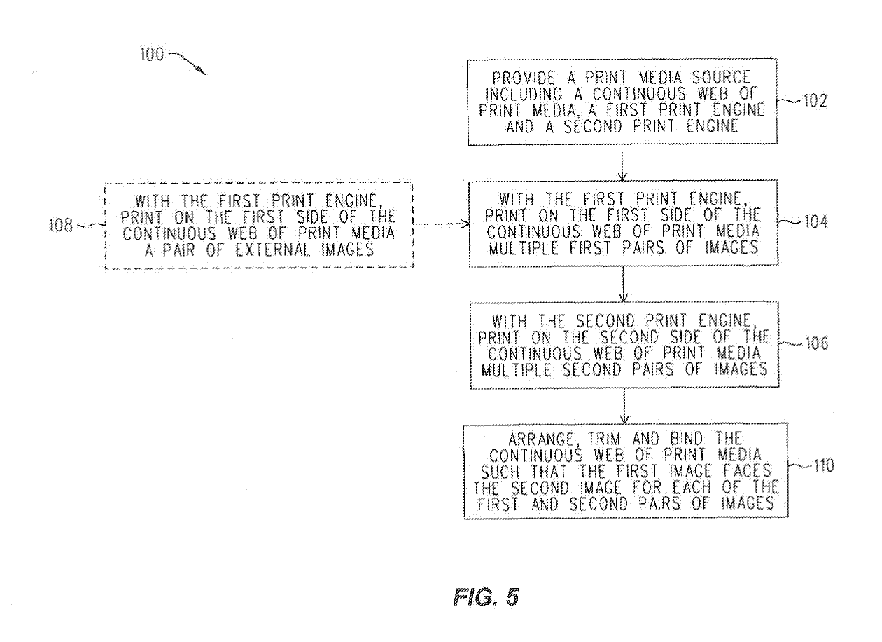

FIGS. 2-5 illustrate a printing method 100 using a dual-engine printing system 10 such as that described above and illustrated in FIG. 1. An initial step 102, FIG. 5, involves providing a print media source 12, FIG. 1, including a continuous web 30, FIG. 2, of print media such as, for example, paper, having a first (or “simplex”) side 32 and a second (or “duplex”) side 34 that is opposite the first side 32. FIG. 2 illustrates both sides 32, 34 of the web 30 of print media, with a bent corner 36 indicating the orientation of the web 30. Also provided are a first print engine 14, FIG. 1, and a second print engine 16 separate from the first print engine 14.

The next steps 104, 106, FIG. 5, involve printing multiple images 40, FIG. 2, on the continuous web 30 of print media with the print engines 14, 16. Specifically, step 104 involves printing multiple first pairs 42, 44, 46, FIG. 2, of images 40 on the first side 32 of the continuous web 30 of print media with the first print engine 14, FIG. 1. Each of the first pairs 42, 44, 46 of images 40 comprises a first image (e.g., 48 in pair 42 and 50 in pair 46) and a second image (e.g., 49 in pair 42 and 51 in pair 46). Step 106 involves printing multiple second pairs 52, 54, 56, 58 of images 40 on the second side 34 of the continuous web 30 of print media with the second print engine 16, FIG. 1. Each of the second pairs 52, 54, 56, 58 of images 40 comprises a first image (e.g., 60 in pair 52 and 62 in pair 58) and a second image (e.g., 61 in pair 52 and 63 in pair 58). Although the terms “first image” and “second image” are singular terms, they may, but do not necessarily refer to single images such as photographs. Instead, as indicated by image pair 44 in FIG. 2, each of the images 40 may be, for example, a single photograph, a collection of photographs, or any other single or multiple images, graphics, photographs, text, or combination thereof that may or may not fill an entire page in an album.

These steps 104, 106 can be performed in any order, with the first print engine 14 completing its printing of the continuous web 30 of print media prior to the second print engine 16, the second print engine 16 completing its printing of the continuous web 30 of print media prior to the first print engine 14, or both print engines 14, 16 printing at approximately the same time. In other words, the continuous web 30 of print media may travel completely through one of the print engines 14 or 16 and then proceed to the other print engine 16 or 14, respectively, or the web 30 may travel partially through one of the print engines (e.g., the first print engine 14) and then proceed to the other print engine (e.g., the second print engine 16) while the remainder of the web 30 is still being printed on by the first print engine 14. Thus, the images 40 shown (the numerals 1, 2, 3, etc.) in FIGS. 2-4 are used herein to indicate the final order of pages in an album 70, and may, but do not necessarily represent the order in which the images 40 are printed by the first print engine 14 and the second print engine 16. Furthermore, the orientation of the images 40 may be different than that shown, e.g., some or all of the images 40 may be printed horizontally rather than vertically as shown.

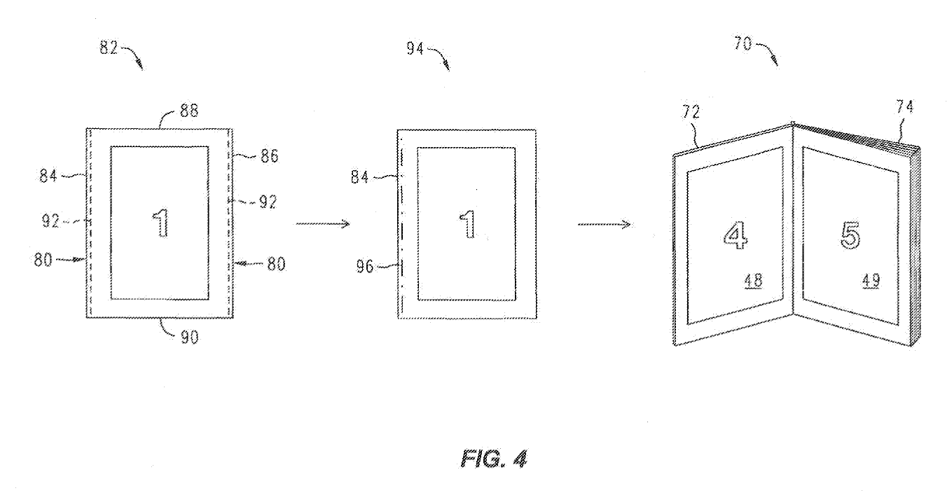

As indicated in FIG. 5, an optional step 108 may be performed using one of the print engines (e.g., the first print engine 14, FIG. 1). Specifically, a pair of external images 64, 66, FIG. 2, may be printed on the first side 32 of the continuous web 30 of print media with the first print engine 14. The pair of external images 64, 66 may be used to create a front cover 72 and back cover 74, respectively, of an album 70, FIG. 4. The first and second pairs 42, 44, 46, 52, 54, 56, 58 of images 40 are positioned between the front cover 72 and the back cover 74 and make up the internal contents of the album 70. As indicated in FIG. 2, the front image 64 (page 1) may be printed opposite the first image (e.g., 60) of one (e.g., 52) of the second pairs 52, 54, 56, 58 of images 40, and the back image 66 (page 16) may be printed opposite the second image (e.g., 63) of another one (e.g., 58) of the second pairs 52, 54, 56, 58 of images 40. Alternatively, the front and/or back images 64, 66 may be printed separately (or the front and/or back covers 72, 74 may be created separately in a manner other than by printing images 64, 66 on a web 30 of print media), or one or both of the front and back covers may not be included at all, whereby the areas on the front side 32 of the web 30 where the front image 64 and/or back image 66 should be printed would be instead be left blank.

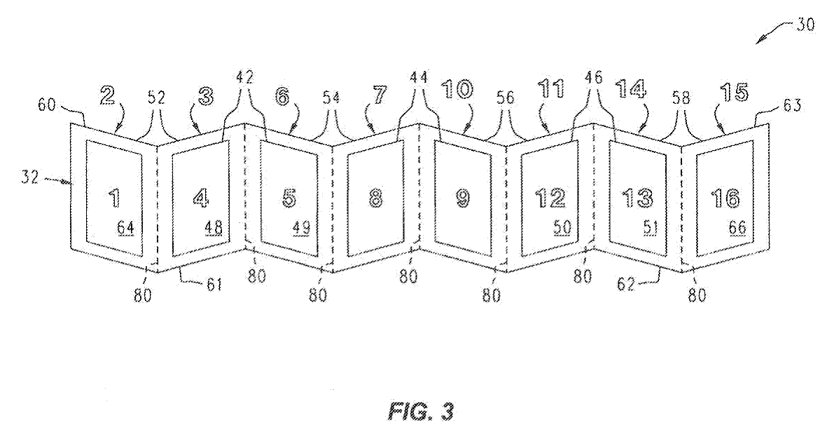

The next step 110 of the method 100, FIG. 5, involves arranging, trimming and binding the continuous web 30 of print media such that the first image (e.g., 48 or 50, FIGS. 2-3) faces the second image (e.g., 49 or 51, respectively) for each of the first pairs 42, 44, 46 of images 40, and the first image (e.g., 60 or 62, FIGS. 2-3) faces the second image (e.g., 61 or 63, respectively) for each of the second pairs 52, 54, 56, 58 of images 40. As illustrated in FIG. 3, this may involve folding the continuous web 30 of print media between the first image (e.g., 48) and the second image (e.g., 49) in each of the first pairs 42, 44, 46 of images 40 and between the first image (e.g., 60) and the second image (e.g., 61) in each of the second pairs 52, 54, 56, 58 of images 40, thereby creating a plurality of fold lines 80 (indicated by dashed lines in FIG. 3). Where a front cover 72, FIG. 4, and/or back cover 74 are printed on the continuous web 30 of print media, the web 30 is also folded between the front image 64, FIG. 3, and the first image (e.g., 48) of one (e.g., 42) of the first pairs 42, 44, 46 of images 40, as well as between the second image (e.g. 51) of one (e.g., 46) of the first pairs 42, 44, 46 of images 40 and the back image 66.

Referring now to FIG. 4, the continuous web 30 of print media is then stacked, thereby creating a stack 82 of attached sheets of images 40, such that the plurality of fold lines 80 are positioned at a periphery (which is defined herein as one or more edges 84, 86, 88, 90) of the stack 82. As shown, if a front cover 72 and/or back cover 74 are printed, the front cover 72 is at the top of the stack 82, the back cover 74 is at the bottom of the stack 82, and the first and second pairs of images 42, 44, 46, 52, 54, 56, 58 (FIG. 3) are positioned therebetween. Next, the periphery (e.g., edges 84, 86) of the stack 82 of attached sheets of images 40 is trimmed at least the plurality of fold lines 80 as indicated by dashed lines 92, thereby creating a stack 94 of separate, unattached sheets of images 40 of substantially the same size (with the front cover 72, if included, being on the top of the stack 94). If desired, the stack 82 of attached sheets can also be trimmed at its top edge 88 and/or bottom edge 90. The stack 94 of separate, unattached sheets may then be bound in any conventional manner such as, for example, stitching at an edge (e.g., 84) thereof as indicated by a dash-dot line 96, thus creating an album 70 which, in this example, has 16 pages or sheets of images 40 including a front cover 72 (page 1) and a back cover 74 (page 16). With this printing method 100, the first and second image in each pair of images will be consecutively-numbered “cross-pages” (pages opposite to and facing one another) printed with the same print engine. Specifically, with the exemplary album 70, the pages (pages 4 and 5) on which the first image 48 and the second image 49 are located are consecutively-numbered cross-pages printed with the first print engine 14 as best shown in FIG. 4, and the pages (pages 12 and 13) on which the first image 50, FIGS. 2-3, and the second image 51 are located are consecutively-numbered cross-pages also printed with the first print engine 14. Similarly, the pages (pages 2 and 3) on which the first image 60, FIG. 2, and the second image 61 are located are consecutively-numbered cross-pages printed with the second print engine 16, and the pages (pages 14 and 15) on which the first image 62, FIG. 2, and the second image 63 are located are consecutively-numbered cross-pages also printed with the second print engine 16.

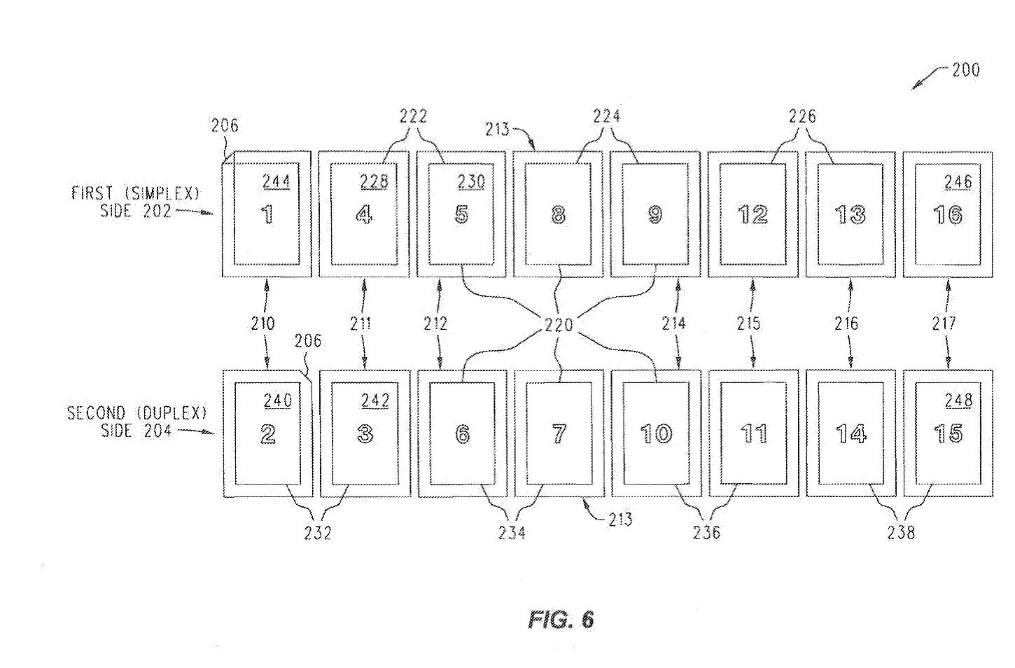

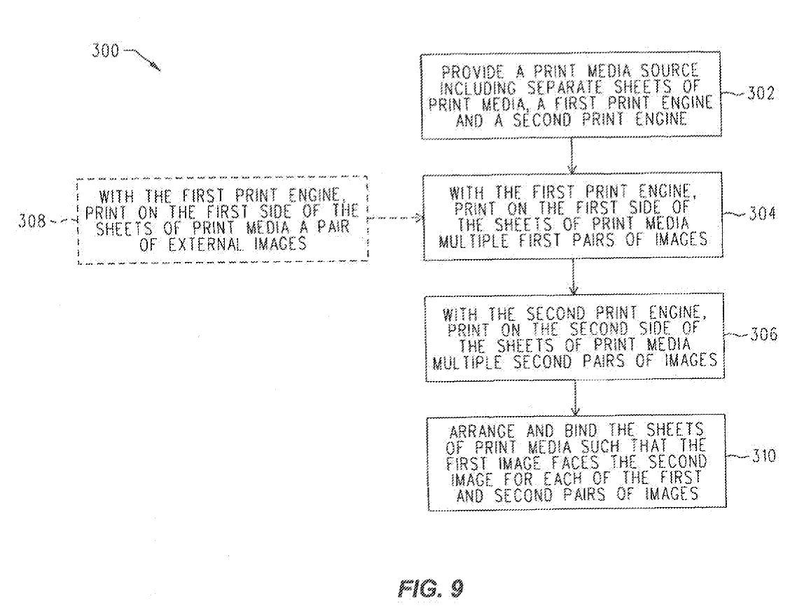

FIGS. 6-9 illustrate another printing method 300 using a dual-engine printing system 10 such as that described above and illustrated in FIG. 1. An initial step 302, FIG. 9, involves providing a print media source 12, FIG. 1, including separate sheets 200, FIG. 6, of print media such as, for example, paper. Each sheet 200 of print media has a first (or “simplex”) side 202 and a second (or “duplex”) side 204 that is opposite the first side 202. FIG. 6 illustrates both sides 202, 204 of several sheets 200 of print media, with a bent corner 206 on a first sheet 210 thereof indicating the orientation of the sheet 210 (with subsequent sheets being oriented in a similar manner). Also provided are a first print engine 14, FIG. 1, and a second print engine 16 separate from the first print engine 14.

The next steps 304, 306 (FIG. 9) involve printing multiple images 220 on the separate sheets 200 of print media with the print engines 14, 16. Specifically, step 304 involves printing multiple first pairs 222, 224, 226, FIG. 6, of images 220 on the first side 202 of consecutive sheets (e.g., 211-216) of print media with the first print engine 14, FIG. 1. Each of the first pairs 222, 224, 226 of images 220 comprises a first image (e.g., 228) and a second image (e.g., 230). Step 306 involves printing multiple second pairs 232, 234, 236, 238 of images 220 on the second side 204 of consecutive sheets (e.g., 210-217) of print media with the second print engine 16, FIG. 1. Each of the second pairs 232, 234, 236, 238 of images 220 comprises a first image (e.g., 240) and a second image (e.g., 242). Again, each of the images 220 may be, for example, a single photograph, a collection of photographs, or any other single or multiple images, graphics, photographs, text, or combination thereof that may or may not fill an entire page in an album.

These steps 304, 306 can be performed in any order, with the first print engine 14 completing its printing of the sheets 200 of print media prior to the second print engine 16, the second print engine 16 completing its printing of the sheets 200 of print media prior to the first print engine 14, or both print engines 14, 16 printing at approximately the same time. In other words, one, some or all of the separate sheets 200 of print media may travel through one of the print engines 14 or 16 and then proceed to the other print engine 16 or 14, respectively. Thus, the images 220 shown (the numerals 1, 2, 3, etc.) in FIGS. 6-8 are used herein to indicate the final order of pages in an album 250, and may, but do not necessarily represent the order in which the images 220 are printed by the first print engine 14 and the second print engine 16. Furthermore, the orientation of the images 220 may be different than that shown, e.g., some or all of the images 220 may be printed horizontally rather than vertically as shown.

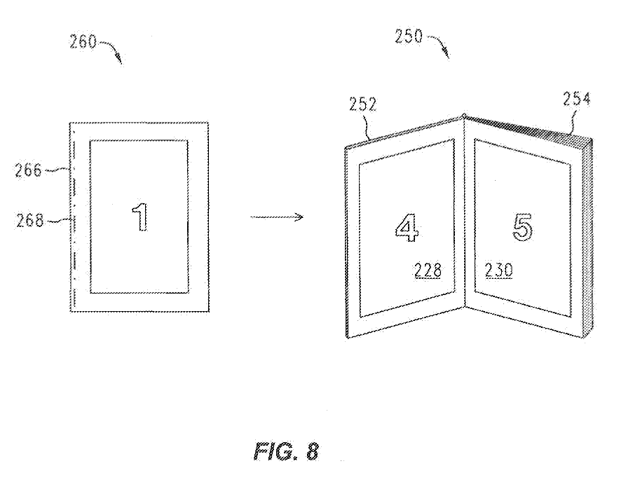

As indicated in FIG. 9, an optional step 308 may be performed using one of the print engines (e.g., the first print engine 14, FIG. 1). Specifically, a pair of external images (e.g., 244, 246) may be printed on the first side 202 of two nonconsecutive sheets (e.g., 210, 217) of print media with the first print engine 14. The pair of external images 244, 246 may be used to create a front cover 252 and back cover 254, respectively, of an album 250, FIG. 8. The first and second pairs 222, 224, 226, 232, 234, 236, 238 of images 220 are positioned between the front cover 252 and the back cover 254 and make up the internal contents of the album 250. As indicated in FIG. 6, the front image 244 (page 1) may be printed on the opposite side of the same sheet (e.g., 210) as a first image (e.g., 240) in one (e.g., 232) of the second pairs 232, 234, 236, 238 of images 220. The back image 246 (page 16) may be printed on the opposite side of the same sheet (e.g., 217) as a second image (e.g., 248) in another one (e.g., 238) of the second pairs 232, 234, 236, 238 of images 220. Alternatively, the front and/or back images may be printed separately (or the front and/or back covers 252, 254 may be created separately in a manner other than by printing images on sheets 200 of print media), or one or both of the front and back covers may not be included at all, whereby the first side 202 of the first sheet 210 and the first side 202 of the last sheet 217 would be left blank.

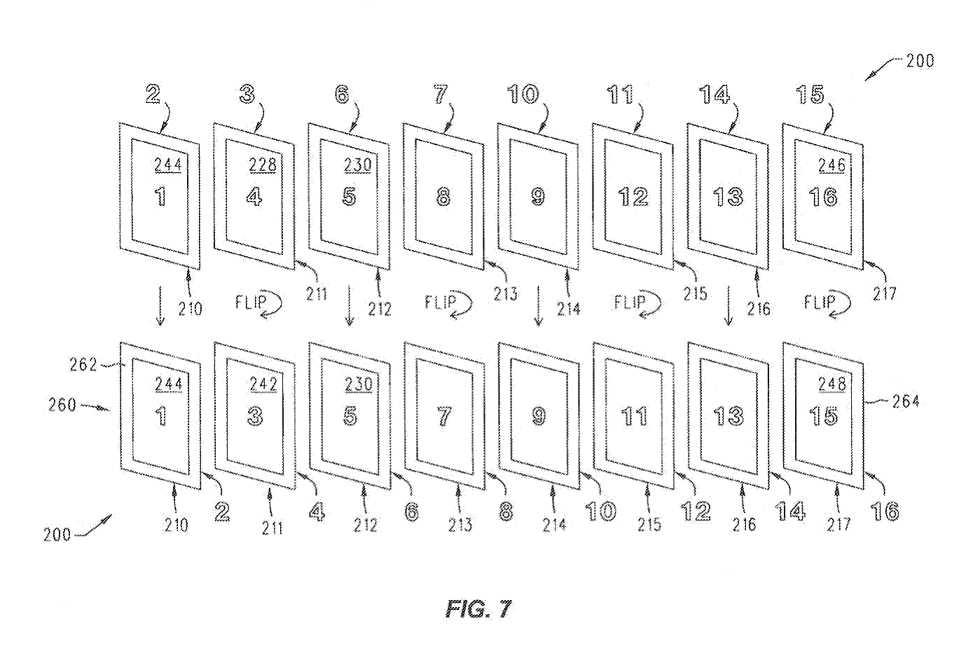

The next step 310 of the method 300, FIG. 9, involves arranging and binding the separate sheets 200 of print media such that the first image (e.g., 228, FIGS. 6-7) faces the second image (e.g., 230) for each of the first pairs 222, 224, 226 of images 220, and the first image (e.g., 240, FIG. 6) faces the second image (e.g., 242) for each of the second pairs 232, 234, 236, 238 of images 220. As illustrated in FIG. 7, this may involve flipping over every other sheet (e.g., 211, 213, 215, 217) of the separate sheets 200 of print media and arranging the sheets 200, thereby creating a stack 260, FIGS. 7-8, of sheets 200. When every other sheet (e.g., 211, 213, 215, 217) is flipped over, it can be seen in FIG. 7 that the sheets 200 will be in numerical order (pages 1-16) from the top (or front) 262 of the stack 260 to the bottom (or back) 264 of the stack 260. In addition, for each of the first and second pairs 222, 224, 226, 232, 234, 236, 238 of images 220, the first image (e.g. 228 or 240) will face the second image (e.g. 230 or 242, respectively). For example, with the exemplary album 250, sheets 211 (pages 314), 213 (pages 7/8), 215 (pages 11/12) and 217 (pages 15/16) may be flipped over such that page 2 (sheet 210) faces page 3 (sheet 211), page 4 (sheet 211) faces page 5 (sheet 212), etc. Where a front cover 252, FIG. 8, and/or back cover 254 are also printed, the front cover 252 will be at the top (or front) 262 of the stack 260 and the back cover 254 will be at the bottom (or back) 264 of the stack 260. The stack 260 of sheets 200 may then be bound in any conventional manner such as, for example, stitching at an edge (e.g., 266) thereof as indicated by a dash-dot line 268, thus creating an album 250 which, in this example, has 16 pages or sheets of images 220 including a front cover 252 (page 1) and a back cover 254 (page 16). With this printing method 300, the first and second image in each pair of images will be consecutively-numbered “cross-pages” (pages opposite to and facing one another) printed with the same print. Thus, with the exemplary album 250, the first side 202 of sheets 211 and 212 are consecutively-numbered cross-pages (pages 4 and 5, respectively) printed with the first print engine 14, as shown in FIGS. 7-8. The first side 202 of sheets 213 and 214 are consecutively-numbered cross-pages (pages 8 and 9, respectively) also printed with the first print engine 14. The first side 202 of sheets 215 and 216 are consecutively-numbered cross-pages (pages 12 and 13, respectively) also printed with the first print engine 14. Similarly, the second side 204 of sheets 210 and 211 are consecutively-numbered cross-pages (pages 2 and 3, respectively) printed with the second print engine 16. The second side 204 of sheets 212 and 213 are consecutively-numbered cross-pages (pages 6 and 7, respectively) also printed with the second print engine 16. The second side 204 of sheets 214 and 215 are consecutively-numbered cross-pages (pages 10 and 11, respectively) also printed with the second print engine 16. The second side 204 of sheets 216 and 217 are consecutively-numbered cross-pages (pages 14 and 15, respectively) also printed with the second print engine 16.

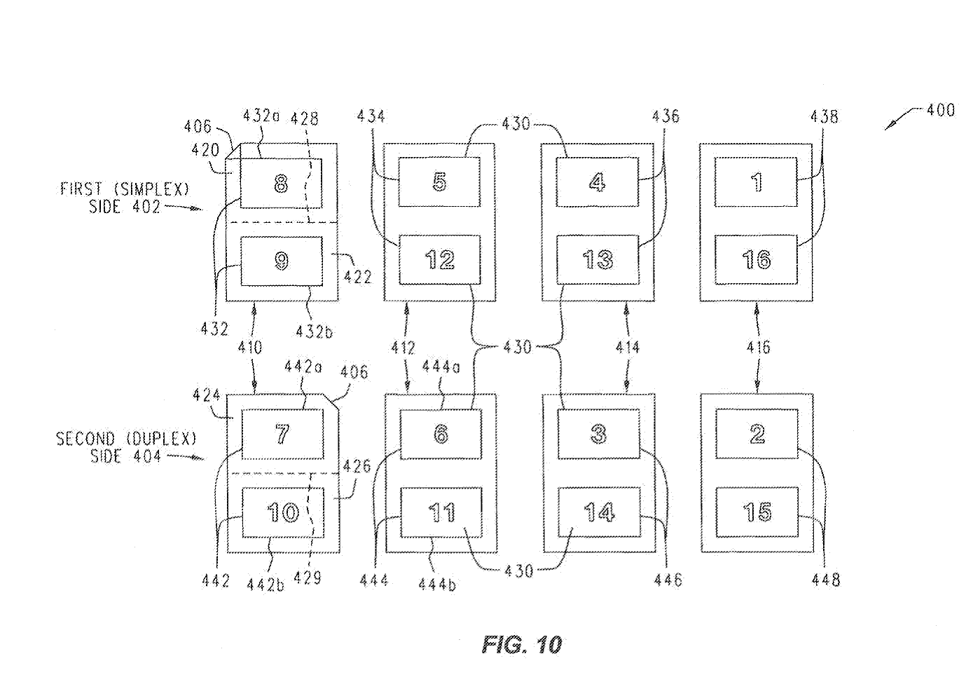

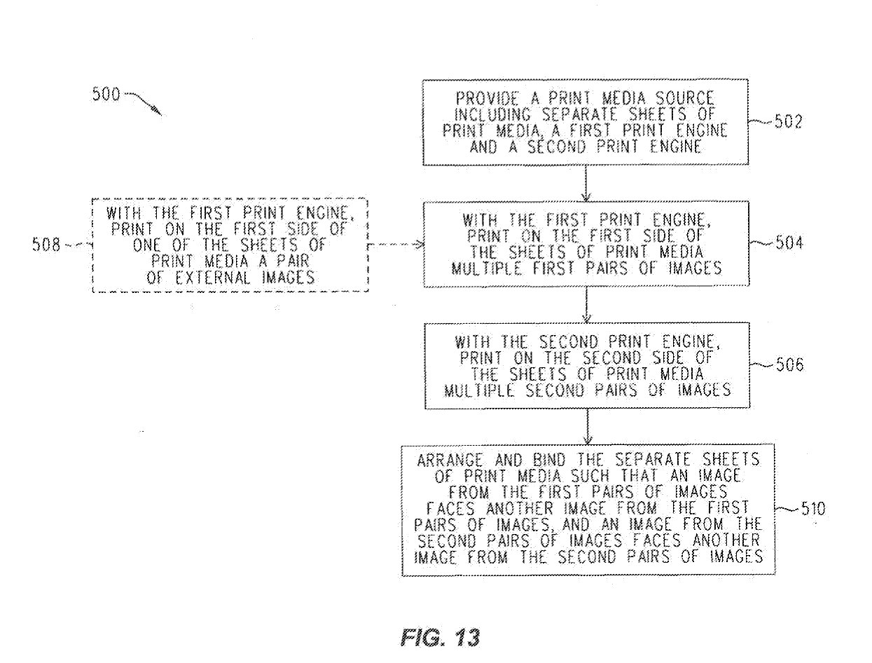

FIGS. 10-13 illustrate another printing method 500 using a dual-engine printing system 10 such as that described above and illustrated in FIG. 1. An initial step 502, FIG. 13, involves providing a print media source 12, FIG. 1, including separate sheets 400, FIG. 10, of print media such as, for example, paper. Each sheet 400 of print media has a first (or “simplex”) side 402 and a second (or “duplex”) side 404 that is opposite the first side 402. FIG. 10 illustrates both sides 402, 404 of several sheets 400 of print media, with a bent corner 406 on a first sheet 410 thereof indicating the orientation of the sheet 410 (with subsequent sheets being oriented in a similar manner). Also provided are a first print engine 14, FIG. 1, and a second print engine 16 separate from the first print engine 14. The first side 402 of each sheet (e.g., 410) of print media has a first half (e.g., 420) and a second half (e.g., 422). The second side 404 of each sheet (e.g., 410) of print media also has a first half (e.g., 424) and a second half (e.g., 426). Imaginary (dashed) lines 428 and 429 separate the first and second halves 420, 422 and 424, 426, respectively, in FIG. 10. The first and second halves (e.g., 420, 422, 424, 426) of each of the sheets (e.g., 410) are preferably approximately the same size.

The next steps 504, 506 (FIG. 13) involve printing multiple images 430 on each half (e.g., 420, 422, 424, 426) of the separate sheets 400 of print media with the print engines 14, 16. Specifically, step 504 involves printing multiple first pairs 432, 434, 436, FIG. 10, of images 430 on the first side 402 of consecutive sheets (e.g., 410, 412, 414) of print media with the first print engine 14. Each of the first pairs 432, 434, 436 of images 430 comprises a first image (e.g., 432a) printed on the first half (e.g., 420) of a sheet (e.g., 410) and a second image (e.g., 432b) printed on the second half (e.g., 422) of the same sheet (e.g., 410). Step 506 involves printing multiple second pairs 442, 444, 446, 448 of images 430 on the second side 404 of consecutive sheets (e.g., 410, 412, 414, 416) of print media with the second print engine 16. Each of the second pairs 442, 444, 446, 448 of images 430 comprises a first image (e.g., 442a) printed on the first half (e.g., 424) of a sheet (e.g., 410) and a second image (e.g., 442b) printed on the second half (e.g., 426) of the same sheet (e.g., 410). Like the images 40 described above, each of the images 430 may be, for example, a single photograph, a collection of photographs, or any other single or multiple images, graphics, photographs, text, or combination thereof that may or may not fill an entire half-page in an album.

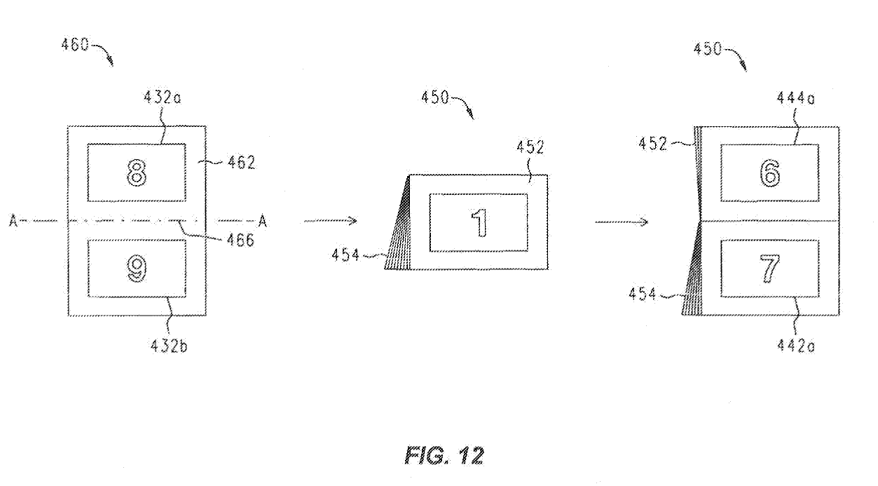

These steps 504, 506 can be performed in any order, with the first print engine 14 completing its printing of the sheets 400 prior to the second print engine 16, the second print engine 16 completing its printing of the sheets 400 prior to the first print engine 14, or both print engines 14, 16 printing at approximately the same time. In other words, one, some or all of the separate sheets 400 of print media may travel through one of the print engines 14 or 16 and then proceed to the other print engine 16 or 14, respectively. Thus, the images 430 shown (the numerals 1, 2, 3, etc.) in FIGS. 10-13 are used herein to indicate the final order of pages in an album 450, and may, but do not necessarily represent the order in which the images 430 are printed by the first print engine 14 and/or the second print engine 16. Furthermore, the orientation of the images 430 may be different than that shown, e.g., some or all of the images 430 may be printed vertically rather than horizontally as shown. As indicated in FIG. 13, an optional step 508 may be performed using one of the print engines (e.g., the first print engine 14, FIG. 1). Specifically, a pair of external images 438, FIG. 10, may be printed on the first side 402 of one of the sheets (e.g., 416) of print media with the first print engine 14. The pair of external images 438 may be used to create a front cover 452 and back cover 454, respectively, of an album 450 (FIG. 12). The first and second pairs 424, 434, 436, 442, 444, 446, 448 of images 430 are positioned between the front cover 452 and the back cover 454 and make up the internal contents of the album 450. Unlike the previous methods 100, 300 described above, as shown in. FIG. 13, the front image (page 1) may be printed on the same sheet (e.g., 416) as the back image (page 16). Alternatively, the front and/or back images may be printed separately (or the front and/or back covers 452, 454 may be created separately in a manner other than by printing images on a sheet 416 of print media), or one or both of the front and back covers may not be included at all, whereby the first side 402 of one (e.g., 416) of the sheets 400 would be left blank.

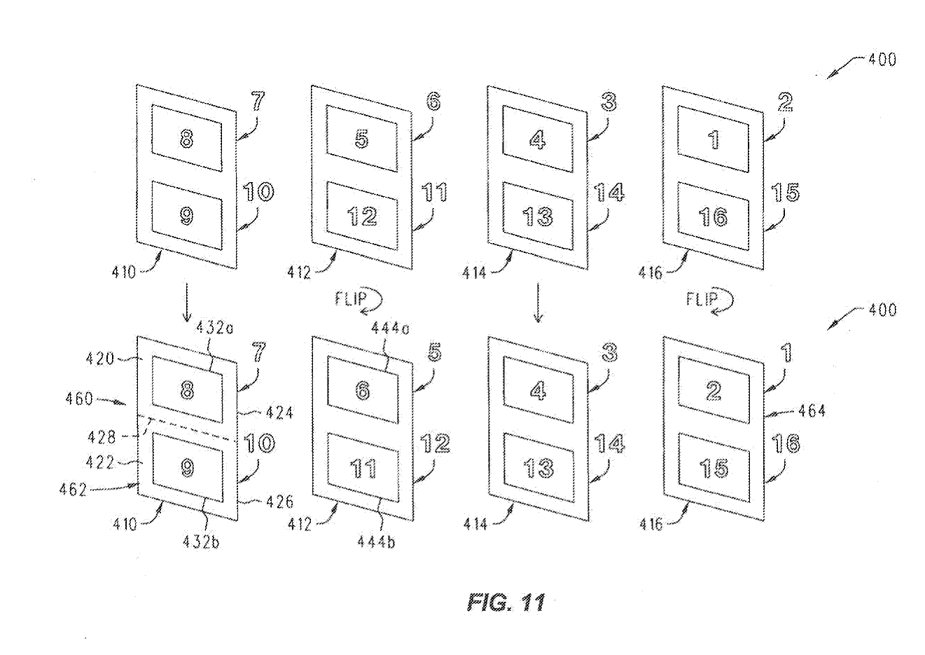

The next step 510 of the method 500, FIG. 13, involves arranging and binding the separate sheets 400 of print media such that, for each of the sheets 400, an image from the first pairs 432, 434, 436 of images faces another image from the first pairs 432, 434, 436 of images 430, and an image from the second pairs 442, 444, 446, 448 of images 430 faces another image from the second pairs 442, 444, 446, 448 of images 430. As illustrated in FIG. 11, this may involve flipping over every other sheet (e.g., sheets 412 and 416) and arranging the sheets 400 of print media, thereby creating a stack 460 of sheets 400 having a central axis AA, FIG. 12. When every other sheet is flipped over, it can be seen in FIG. 11 that the first half (e.g., 420, 424) of each of the sheets 400 will be in numerical order (pages 1-8) from the bottom (or back) 464 of the stack 460 to the top (or front) 462 of the stack 460. In addition, the second half (e.g., 422, 426) of each of the sheets 400 will be in numerical order (pages 9-16) from the top (or front) 462 of the stack 460 to the bottom (or back) 464 of the stack 460. As illustrated in FIG. 12, the stack 460 of sheets 400 may then be bound by any conventional means such as, for example, stitching along a central axis AA thereof as indicated by a dash-dot line 466, and then folding the sheets 400 over at the central axis AA to create an album 450 which, in this example, has 16 pages or half-sheets of images 430 including a front cover 452 (page 1) and a back cover 454 (page 16). With this printing method 500, two images in each of the first and second pairs of images will be consecutively-numbered “cross-pages” (pages opposite to and facing one another) printed with the same print engine. These cross-pages may be on the same or different sheets. i.e., the first image 432a (page 8) and its cross-page, the second image 432b (page 9), are both printed on sheet 410 as shown in FIG. 11, and this sheet 410 was printed using the first print engine 14. However, the first image 444a (page 6) is printed on sheet 412 and its cross-page, the second image 442a (page 7) is printed on sheet 410, but both of these sheets 410, 412 were printed using the second print engine 16.

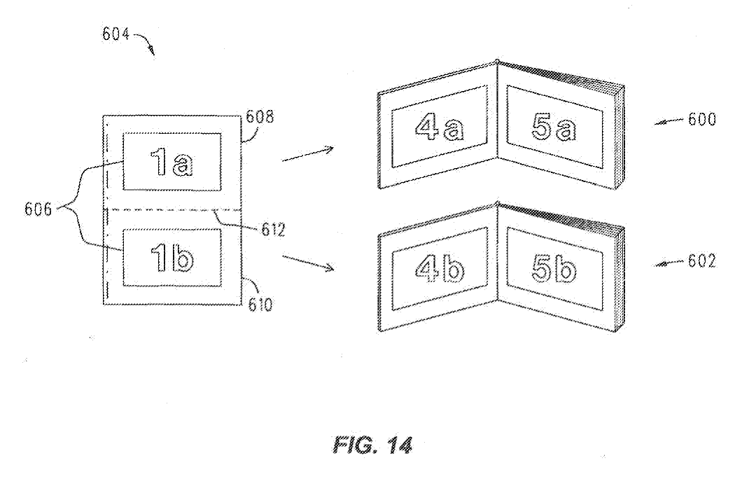

As indicated in FIG. 14, any of the methods 100, 300, 500, may be used to create multiple albums 600, 602 from a single stack 604 of images 606. For example, each sheet in the stack 604 may include a first half 608 and a second half 610. The images 606 thereon may be printed on each half 608, 610 in accordance with one of the methods 100, 300, 500 described above. Again, while a single image 606 is shown, it is to be understood that each of the images 606 may be, for example, a single photograph, a collection of photographs, or any other single or multiple images, graphics, photographs, text, or combination thereof that may or may not fill an entire page (methods 100, 300) or half-page (method 500) in an album. In addition, while two halves 608, 610 and two albums 600, 602 are shown, it is to be understood that any number of albums may be created from a single stack of images. Thus, the stack 604 of images 606 may be cut at, for example, the dashed line 612 (i.e., in half for two albums, in thirds for three albums, etc.) to create multiple albums 600, 602. Furthermore, the multiple albums 600, 602 may be identical wherein the images 606 on each portion of a page (e.g., on each half 608, 610 of page 1a/1b) are the same, or any or all of the multiple albums 600, 602 may be different from one another and include different images 606.

While illustrative and presently preferred embodiments have been described in detail herein, it is to be understood that the inventive concepts may be otherwise variously embodied and employed, and that the appended claims are intended to be construed to include such variations, except as limited by the prior art.

What is claimed is:

1. A method for printing using a dual-engine printing system, comprising:
providing a print media source including a continuous web of print media having a first side and a second side opposite the first side, a first print engine and a second print engine separate from the first print engine;
with the first print engine, printing on the first side of the continuous web of print media multiple first pairs of images, wherein each of the first pairs of images comprises a first image and a second image;
with the second print engine, printing on the second side of the continuous web of print media multiple second pairs of images, wherein each of the second pairs of images comprises a first image and a second image; and
arranging, trimming and binding the continuous web of print media such the first image faces the second image for each of the first pairs of images, and the first image faces the second image for each of the second pairs of images.

2. The method of claim 1, further comprising printing with the first print engine on the first side of the continuous web of print media a pair of external images comprising a front image and a back image, and arranging, trimming and binding the continuous web of print media such that the front image creates a front cover and the back image creates a back cover of an album, and the first pairs of images and second pairs of images create internal contents of the album that are positioned between the front cover and back cover of the album.

3. The method of claim 1, wherein arranging, trimming and binding the continuous web of print media comprises:
folding the continuous web of print media between the first image and the second image in each of the first pairs of images and between the first image and the second image in each of the second pairs of images, thereby creating a plurality of fold lines;
stacking the continuous web of print media, thereby creating a stack of attached sheets of images, such that the plurality of fold lines are positioned at a periphery of the stack of attached sheets of images;
trimming the periphery of the stack at least the plurality of fold lines, thereby creating a stack of separate, unattached sheets of images having substantially the same size; and
binding the stack of separate, unattached sheets of images at an edge thereof.

4. The method of claim 2, wherein arranging, trimming and binding the continuous web of print media comprises:
folding the continuous web of print media between the front image and the first image of one of the first pairs of images, between the first image and the second image of each of the first pairs of images, between the first image and the second image of each of the second pairs of images, and between the second image of one of the first pairs of images and the back image, thereby creating a plurality of fold lines;
stacking the continuous web of print media, thereby creating a stack of sheets, such that the plurality of fold lines are positioned at the periphery of the stack of sheets;
trimming the periphery of the stack of sheets at least the plurality of fold lines, thereby creating a stack of separate, unattached sheets of images having substantially the same size, wherein the front image is on the top of the stack, the back image is on the bottom of the stack, and the first pairs of images and second pairs of images are positioned between the top and bottom of the stack; and
binding the stack of separate, unattached sheets of images at an edge thereof.

5. The method of claim 1, further comprising cutting the continuous web of print media to create multiple albums.

6. A method for printing using a dual-engine printing system, comprising:
providing a print media source including separate sheets of print media each having a first side and a second side opposite the first side, a first print engine and a second print engine separate from the first print engine;
with the first print engine, printing on the first side of the sheets of print media from the print media source multiple first pairs of images, wherein each of the first pairs of images comprises a first image and a second image;
with the second print engine, printing on the second side of the sheets of print media from the print media source multiple second pairs of images, wherein each of the second pairs of images comprises a first image and a second image; and
arranging and binding the sheets of print media such that the first image faces the second image for each of the first pairs of images, and the first image faces the second image for each of the second pairs of images.

7. The method of claim 6, further comprising printing with the first print engine on the first side of the sheets of print media a pair of external images comprising a front image and a back image, and arranging and binding the sheets of print media such that the front image creates a front cover and the back image creates a back cover of an album, and the first pairs of images and second pairs of images create internal contents of the album that are positioned between the front cover and back cover of the album.

8. The method of claim 6, wherein arranging and binding the sheets of print media comprises:
flipping over every other sheet and stacking the sheets of print media, thereby creating a stack of sheets; and
binding the stack of sheets at an edge thereof.

9. The method of claim 7, wherein arranging and binding the sheets of print media comprises:
flipping over every other sheet and stacking the sheets of print media, thereby creating a stack of sheets, such that the front image is on the top of the stack, the back image is on the bottom of the stack, and the first pairs of images and second pairs of images are positioned between the top and the bottom of the stack; and
binding the stack of sheets at an edge thereof.

10. The method of claim 5, further comprising cutting the sheets of print media to create multiple albums.

11. A method for printing using a dual-engine printing system, comprising:
providing a first print engine, a second print engine separate from the first print engine, and a print media source including separate sheets of print media each having a first side and a second side opposite the first side, wherein the first side of each sheet has a first half and a second half, and the second side of each sheet has a first half and a second half;
with the first print engine, printing on the first side of the sheets of print media from the print media source multiple first pairs of images, wherein each of the first pairs of images comprises an image printed on the first half of a sheet and another image printed on the second half of the sheet;
with the second print engine, printing on the second side of the sheets of print media multiple second pairs of images, wherein each of the second pairs of images comprises an image printed on the first half of a sheet and another image printed on the second half of the sheet; and
arranging and binding the sheets of print media such that, for each of the sheets, each image from the first pairs of images faces another image from the first pairs of images, and each image from the second pairs of images faces another image from the second pairs of images.

12. The method of claim 11, further comprising printing with the first print engine on the first side of one of the sheets of print media a pair of external images comprising a front image and a back image, and arranging and binding the multiple sheets of print media such that the front image creates a front cover and the back image creates a back cover of an album, and the first pairs of images and second pairs of images create internal contents of the album that are positioned between the front cover and back cover of the album.

13. The method of claim 11, wherein arranging and binding the sheets of print media comprises:
flipping over every other sheet and arranging the sheets of print media, thereby creating a stack of sheets having a central axis; and
binding and folding the stack of sheets along the central axis.

14. The method of claim 12, wherein arranging and binding the sheets of print media comprises:
flipping over every other sheet and arranging the sheets of print media, thereby creating a stack of sheets; and
binding and folding the stack of sheets along the central axis.

15. The method of claim 11, further comprising cutting the sheets of print media to create multiple albums.
